(19) United States
(12) Patent Application Publication
(10) Pub. No.: US 2011/0093181 A1
(43) Pub. Date: Apr. 21, 2011

(54) METHOD FOR BIODIESEL BLENDING DETECTION BASED ON INTERNAL MEAN EFFECTIVE PRESSURE EVALUATION

(75) Inventors: Claudio CIARAVINO, Torino (IT); Alberto VASSALLO, Torino (IT); Federico Luigi GUGLIELMONE, Rivoli (IT)

(73) Assignee: GM GLOBAL TECHNOLOGY OPERATIONS, INC., Detroit, MI (US)

(21) Appl. No.: 12/906,931

(22) Filed: Oct. 18, 2010

(30) Foreign Application Priority Data
Oct. 19, 2009 (GB) 0918272.6

(51) Int. Cl. G01M 15/08

(52) U.S. Cl. 701/102

(57) ABSTRACT

A method for biodiesel blending detection in a internal combustion engine includes, but is not limited to a first evaluation of the internal mean effective pressure (IMEP) by means of measurements provided by a first sensor whose output is representative of the actual IMEP value, a second evaluation of the internal mean effective pressure (IMEP) performed measuring fuel conversion efficiency (FCE), injected fuel quantity (Q_{fuel}) and lower heating value LHV and carrying out the evaluation by means of the Electronic Control Unit (ECU) of the engine, and determining discrepancies of values obtained from the second evaluation compared with values obtained from the first evaluation.

### CROSS-REFERENCE TO RELATED APPLICATION

This application claims priority to British Patent Application No. 0918272.6, filed Oct. 19, 2009, which is incorporated herein by reference in its entirety.

### TECHNICAL FIELD

The present invention relates to a method for biodiesel blending detection based on internal mean effective pressure (IMEP) estimation by the electronic control unit (ECU) of the vehicle.

### BACKGROUND

Biodiesel can be used in pure form or may be blended with petroleum diesel at any concentration in modern diesel engines of the last generation. It may be foreseen that use of biodiesel will increase in the future especially due to the advantages of such type of fuel. In particular using biodiesel may have the effect of a particulate reduction up to 80%. Furthermore, biodiesel gives the possibility of recalibrating the Soot-NOx trade-off in order to eliminate increase of NOx. Also it gives the possibility of reducing the regeneration frequency of the antiparticulate filter.

However, the use of biodiesel is not without problems; for example with biodiesel cold start of the motor may be more difficult, especially at low temperatures, with respect to conventional petrodiesel. A further problem is given by increased oil dilution due to the inferior evaporability of biodiesel. Moreover use of biodiesel may have the effect of reducing the power of the motor by 7-10%. Furthermore use of biodiesel may lead to an increase of nitrogen oxides emission up to 60%.

At least one object of the present invention is to enable the detection of biodiesel in the vehicle tank as well as to provide an estimate of the percentage volume of biodiesel as accurate as possible. At least another object is to provide this estimate without using dedicated sensors and using only existing engine sensors and data already available to the ECU. At least yet another object of the present invention is to meet the goal with a rational and inexpensive solution. In addition, other objects, desirable features, and characteristics will become apparent from the subsequent summary and detailed description, and the appended claims, taken in conjunction with the accompanying drawings and this background.

### SUMMARY

A method is provided for biodiesel blending detection in a internal combustion engine comprising the following steps of a first evaluation of the internal mean effective pressure (IMEP) by means of measurements provided by at least a first sensor whose output is representative of the actual IMEP value in order to use such first evaluation as a reference value; a second evaluation of the internal mean effective pressure (IMEP) performed measuring fuel conversion efficiency (FCE), injected fuel quantity (Q_{fuel}) and lower heating value LHV of petrodiesel and carrying out said second evaluation by means of the Electronic Control Unit (ECU) of said engine; determining a discrepancy between the values obtained from the first and second evaluation. With this method, a biodiesel blending can be detected without extra hardware and thus without extra costs by using information which is anyhow available in the vehicle. Preferably the method comprises the further step of using a pre-calculated correlation set of values between said discrepancies of values and biodiesel percentage with respect to petrodiesel in order to determine a value of biodiesel blending. Therefore monitoring and comparison of internal mean effective pressure (IMEP) in an internal combustion engine is evaluated in two different ways.

The first evaluation is based on a direct measurement of the internal mean effective pressure (IMEP) of the engine, preferably using a direct measurement by integrating the in-cylinder pressure trace provided by pressure-sensing glow plugs. Such evaluation is not sensitive to the actual biodiesel blending in the vehicle tank and may be used as a reference representing the actual IMEP value.

The second evaluation estimates internal mean effective pressure (IMEP) from measurements of fuel conversion efficiency of the engine (FCE), injected fuel quantity Q_{fuel} and lower heating value LHV of petrodiesel, all of which is information already available to the ECU of the vehicle. Since lower heating value LHV is sensitive to biodiesel blending, the RAFR calculated according to this parameter shows increasing discrepancy from the correct value as a function of the increase of the biodiesel percentage with respect to petrodiesel, giving a measure of biodiesel blending. Therefore, by comparing the first direct IMEP measurement from the sensor with the second IMEP estimation obtained using the ECU of the vehicle, it is possible to determine biodiesel fuelling and blending ratio.

The steps of the method can be repeated continuously in order to achieve a continuous monitoring of the biodiesel percentage.

The method can be realized in the form of a computer program comprising a program-code to carry out all the steps of the method of the invention and in the form of a computer program product comprising means for executing the computer program. The computer program product comprises, according to a preferred embodiment of the invention, a control apparatus for an IC engine, for example the ECU of the engine, in which the program is stored so that the control apparatus defines the invention in the same way as the method. In this case, when the control apparatus executes the computer program, all the steps of the method according to the invention are carried out.

The method according to the invention can be transmitted by an electromagnetic signal, said signal being modulated to carry a sequence of data bits which represent a computer program to carry out the method.

The invention further provides an internal combustion engine specially arranged for carrying out the detection method.

Further objects, features and advantages of the present invention will be apparent from the detailed description of preferred embodiments that follows, when considered together with the accompanying drawing.

### BRIEF DESCRIPTION OF THE DRAWINGS

The present invention will hereinafter be described in conjunction with the following drawing figures, wherein like numerals denote like elements, and

FIG. 1 is a schematic representation of the steps of the method according to an embodiment of the invention; and

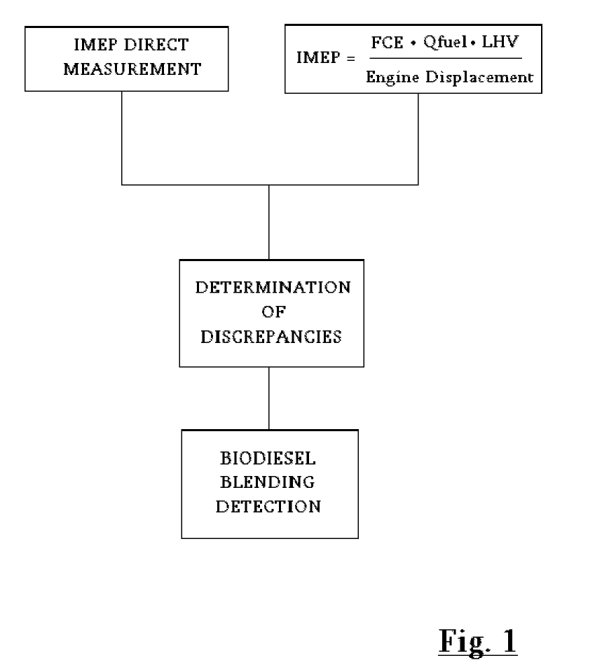

FIG. 2 is a histogram representative of experimental data to support the fact that FCE and Q_{fuel} do not show appreciable changes due to biodiesel fuelling.

### DETAILED DESCRIPTION

The following detailed description is merely exemplary in nature and is not intended to limit application and uses. Furthermore, there is no intention to be bound by any theory presented in the preceding background or summary or the following detailed description.

The method allows to detection of the percentage of blending of biodiesel in regular diesel fuel through the differences in combustion with respect to petrodiesel caused by its properties. Being the lower heating value, LHV, one of the main differences between biodiesel and regular petrodiesel fuel, the method uses its effect on the internal mean effective pressure (IMEP) estimate to detect the percentage of blending. More specifically, internal mean effective pressure (IMEP) can be evaluated in two alternate ways; a first evaluation of the internal mean effective pressure (IMEP) is provided by means of measurements provided by a first sensor whose output is substantially independent from the fuel specifications and gives actual IMEP value. This evaluation is preferably performed as a direct measurement by integrating the in-cylinder pressure trace provided by pressure-sensing glow plugs.

The second way to evaluate IMEP is performed combining information expressed by the following equation:

$$I M E P = \frac{F C E \cdot Q fuel \cdot L H V}{Engine Displacement} \qquad ( 1 )$$

Where FCE is the fuel conversion efficiency of the engine, Q_{fuel} is the injected fuel quantity and LHV is the lower heating value of petrodiesel.

The parameters of the equation are evaluated preferentially considering data available to the ECU for the whole engine. Therefore any variations on those quantities that are not considered would produce a discrepancy between true IMEP evaluated by glow plug sensors and the approximated one of equation (1). In other words, if equation (1) is evaluated using both Q_{fuel} and LHV corresponding to petrodiesel while the engine is actually fuelled with biodiesel or blends thereof, any discrepancies thereof can thus be considered a measure of biodiesel blending ratio.

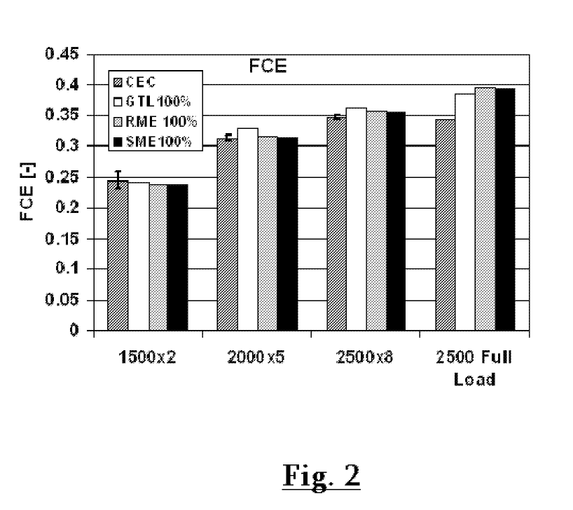

Experimental data support the fact that FCE and Q_{fuel} do not show appreciable changes due to biodiesel fuelling (except at full load due to increased combustion efficiency, as opacity with biodiesel is almost negligible). Such experimental data is represented in the enclosed FIG. 2.

Concerning Q_{fuel} sensitivity to biodiesel fuelling, the following Table 1 illustrates variations in the statistic range from engine working point to working point:

TABLE 1

| | | | | Reference | | Reference | | Reference | | | |
|---|---|---|---|---|---|---|---|---|---|---|---|
| | | | | diesel | | diesel | | diesel fuel + | | Reference diesel | |
| | | | | fuel | | fuel + GTL | | RME | | fuel + SME | |
| | | | | [ρ = 0.84 kg/l] | | [ρ = 0.81 kg/l] | | [ρ = 0.86 kg/l] | | [ρ = 0.89 kg/l] | |
| | Pᵢₙⱼ | | Q_{totGM} | Pilot | Q_{totIM} | Pilot | Q_{totIM} | Pilot | Q_{totIM} | Pilot | Q_{totIM} |
| rpm | Mpa | Inj. time [μs] | mg/str | mg/str | Mg/str | [mg/str] | [mg/str] | [mg/str] | [mg/str] | [mg/str] | [mg/str] |
| 1500 × 2 | 50 | 260_990_600 | 9.33 | 0.87 | 9.19 | 1.00 | 10.08 | 0.75 | 9.11 | 0.77 | 8.70 |
| | | | | | | [+14.9%] | [+9.7%] | [−13.8%] | [−0.9%] | [−11.5%] | [−5.3%] |
| 2000 × 5 | 97 | 210_1390_560 | 16.83 | 0.78 | 16.81 | 0.91 | 17.76 | 0.82 | 17.56 | 0.83 | 17.04 |
| | | | | | | [+16.7%] | [+5.6%] | [+5.1%] | [+4.5%] | [+6.4%] | [+1.4%] |
| 2000 | 123 | 200_1400_980 | 60.17 | 0.80 | 61.48 | 1.02 | 58.84 | 0.98 | 61.72 | 0.98 | 60.55 |
| full | | | | | | [+27.5%] | [−4.3%] | [+22.5%] | [+0.4%] | [+22.5%] | [−1.5%] |
| 2500 × 8 | 115 | 200_1400_630 | 24.73 | 0.87 | 24.92 | 1.03 | 26.34 | 0.80 | 27.02 | 0.87 | 25.82 |
| | | | | | | [+18.4%] | [+5.7%] | [−8.0%] | [+8.4%] | [±0.0%] | [+3.6%] |

Considering in particular the values of Q_{totIM} for the RME or for the SME columns in the Table 2 it may be seen that the variations of Q_{fuel} measured are lower than the statistical dispersion due to injection system itself. Therefore, such in-house tests show that the injected quantity variation due to biodiesel fuelling has almost no deterministic influence, since variations measured from working-point to working point can be considered in the statistic range. Therefore, only the change of lower heat value LHV can be accounted for a variation of the IMEP parameter due to biodiesel fuelling.

In this detection strategy therefore, any variations in LHV due to biodiesel fuelling that are not accounted for, would provide a detection criterion. Values measured are:

LHV for petrodiesel=43.1 MJ/kg

LHV for SME biodiesel (B100)=37.25 MJ/kg

LHV for RME biodiesel (B100)=37.35 MJ/kg

Therefore IMEP deviation can be correlated to LHV deviation according to the following table 2, where B0 to B100 indicate corresponding percentages of biodiesel with respect to petrodiesel from 0% to 100%:

TABLE 2

| | LHV | | Delta IMEP wrt B0 | |
|---|---|---|---|---|
| | RME | SME | RME | SME |
| B0 | 43.10 | 43.10 | 0.0% | 0.0% |
| B10 | 42.53 | 42.52 | −1.3% | −1.4% |
| B20 | 41.95 | 41.93 | −2.7% | −2.7% |
| B30 | 41.38 | 41.35 | −4.0% | −4.1% |
| B40 | 40.80 | 40.76 | −5.3% | −5.4% |
| B50 | 40.23 | 40.18 | −6.7% | −6.8% |
| B60 | 39.65 | 39.59 | −8.0% | −8.1% |
| B70 | 39.08 | 39.01 | −9.3% | −9.5% |
| B80 | 38.50 | 38.42 | −10.7% | −10.9% |
| B90 | 37.93 | 37.84 | −12.0% | −12.2% |
| B100 | 37.35 | 37.25 | −13.5% | −13.6% |

TABLE 2

LHV Delta IMEP wrt B0

RME SME RME SME

B0 43.10 43.10 0.0% 0.0%

B10 42.53 42.52-1.3%-1.4%

B20 41.95 41.93-2.7%-2.7%

B30 41.38 41.35-4.0%-4.1%

B40 40.80 40.76-5.3%-5.4%

B50 40.23 40.18-6.7%-6.8%

B60 39.65 39.59-8.0%-8.1%

B70 39.08 39.01-9.3%-9.5%

B80 38.50 38.42-10.7%-10.9%

B90 37.93 37.84-12.0%-12.2%

B100 37.35 37.25

Therefore a correspondence can be made between a measured discrepancy Delta IMEP with respect to petrodiesel fuelling and a corresponding biodiesel percentage that expresses the actual biodiesel blending measured. Also interpolation between values of Table 2 may be performed for increased accuracy since the above correspondence is substantially linear.

Statistical analysis provides the following combined accuracies: IMEP measurement accuracy is in the range of 5%; FCE actual sensitivity to biodiesel, which is neglected in equation (1), is 2%; Q_{fuel} accuracy is 3%. By making a statistical analysis of tolerance of these errors, a combined accuracy of about 6% is determined, which makes the safely detectable blending ratio to approach B50. In addition, the blending detection accuracy would be +/−25%.

In general no significant discrepancies in LHV are apparent among biodiesel types available on the market in Europe, therefore the feedstock source would not impair the above-described detecting strategies.

Detection of biodiesel blends lower than B50 may be less accurate.

The embodiments of the invention have numerous important advantages. As a general rule, biodiesel blending detection allows optimizing a series of parameters of engine performance and may minimize negative issues arising from fuel consumption. In particular, the embodiments of the invention allow for a correction of injection strategies, such as number, phase and period of each injection or such as injection pressure specific for the biodiesel blend at which the engine is working

Concerning engine power, the method may allow calibration of injection period in order to compensate the decrease of calorific value of biodiesel and maintain the power level at the same value of the petrodiesel reference. The optimization of the injection strategy is also useful in order to optimize cold start of the engine by means of calibration, among other parameters, of injection pressure and of the glow plug heating. From an ecological point of view the calibration of the injection strategy allows to maintain NOx emission level to the homologation value corresponding to the petrodiesel reference. At the same time control of air/EGR may be improved specifically as a function of the biodiesel blend.

Since biodiesel requires shorter oil drain intervals, as a consequence of the determinations of the method oil life monitoring is customized to actual engine fuelling. Moreover, since biodiesel may enable longer intervals between DPF regeneration events, soot accumulation specific of biodiesel blend may be estimated by statistical models and therefore DPF regeneration events may be adapted to actual engine fuelling.

Last but not least, no additional sensors are needed to perform the method of the invention and therefore there are no related increase of costs for current diesel engine configuration

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for biodiesel blending detection in an internal combustion engine comprising the steps of:
performing a first evaluation of an internal mean effective pressure (IMEP) with measurements provided by at least a first sensor whose output is representative of an actual IMEP value;
performing a second evaluation of the internal mean effective pressure (IMEP) performed by measuring a fuel conversion efficiency (FCE), a injected fuel quantity (Q_{fuel}) and a lower heating value (LHV) of petrodiesel and carrying out said first evaluation and said second evaluation with an electronic control unit of said internal combustion engine; and
determining a discrepancy between values obtained from the first evaluation and the second evaluation.

2. The method according to claim 1, further comprising the step of using a pre-calculated correlation set of values between said discrepancy of values and a biodiesel percentage with respect to petrodiesel in order to determine a value of biodiesel blending.

3. The method according to claim 1, wherein said first evaluation is performed by integrating an in-cylinder pressure trace provided by pressure-sensing glow plugs.

4. The method according to claim 1, wherein said second evaluation of the internal mean effective pressure (IMEP) is performed according to:
$$I M E P = \frac{F C E \cdot Q fuel \cdot L H V}{Engine Displacement}$$
wherein FCE is a fuel conversion efficiency of the internal combustion engine, Q_{fuel} is an injected fuel quantity and LHV is a lower heating value.

5. The method according to claim 4, a correspondence between an actual lower heating value LHV for biodiesel blend and the IMEP evaluated according to said second evaluation is established with the determining of a value of biodiesel blending.

6. The method according to claim 5, wherein said correspondence is substantially linear in order to allow interpolation of values.

7. The method according to claim 2, further comprising the step of repeating the first evaluation and the second evaluation in order to achieve a continuous monitoring of the biodiesel percentage.

8. The method according to claim 1, wherein the first evaluation and the second evaluation of IMEP are performed considering data available to the electronic control unit for the internal combustion engine.

9. An internal combustion engine, comprising:
a first sensor adapted for measurement of a first combustion parameter; and
an electronic control unit configured to:
perform a first evaluation of an internal mean effective pressure (IMEP) with measurements provided by the first sensor whose output is representative of an actual IMEP value;
perform a second evaluation of the internal mean effective pressure (IMEP) performed by measuring a fuel conversion efficiency (FCE), a injected fuel quantity (Q_{fuel}) and a lower heating value (LHV) of petrodiesel and carrying out said first evaluation and said second evaluation; and
determine a discrepancy between values obtained from the first evaluation and the second evaluation.

10. The internal combustion engine according to claim 9, wherein the internal combustion engine is a diesel engine.

11. The internal combustion engine according to claim 9, said electronic control unit further configured to use a pre-calculated correlation set of values between said discrepancy of values and a biodiesel percentage with respect to petrodiesel in order to determine a value of biodiesel blending.

12. The internal combustion engine according to claim 9, wherein said first evaluation is performed by integrating an in-cylinder pressure trace provided by pressure-sensing glow plugs.

13. The internal combustion engine according to claim 9, wherein said second evaluation of the internal mean effective pressure (IMEP) is performed according to:
$$I M E P = \frac{F C E \cdot Q fuel \cdot L H V}{Engine Displacement}$$
wherein FCE is a fuel conversion efficiency of the internal combustion engine, Q_{fuel} is an injected fuel quantity and LHV is a lower heating value.

14. The internal combustion engine according to claim 9, a correspondence between actual lower heating value LHV for biodiesel blend and the IMEP evaluated according to said second evaluation is established with the determining of a value of biodiesel blending.

15. The internal combustion engine according to claim 14, wherein said correspondence is substantially linear in order to allow interpolation of values.

16. A computer readable medium embodying a computer program product, said computer program product comprising:
a program for biodiesel blending detection in an internal combustion engine, the program configured to:
perform a first evaluation of an internal mean effective pressure (IMEP) with measurements provided by at least a first sensor whose output is representative of an actual IMEP value;
perform a second evaluation of the internal mean effective pressure (IMEP) performed by measuring a fuel conversion efficiency (FCE), a injected fuel quantity (Q_{fuel}) and a lower heating value (LHV) of petrodiesel and carrying out said first evaluation and said second evaluation; and
determine a discrepancy between values obtained from the first evaluation and the second evaluation.

17. The computer readable medium embodying the computer program product of claim 16, the program is further configured to: repeating the first evaluation and the second evaluation in order to achieve a continuous monitoring of a biodiesel percentage.

18. The computer readable medium embodying the computer program product of claim 16, wherein the program is further configured to perform the first evaluation and the second evaluation of IMEP considering data available for the internal combustion engine.

19. The computer readable medium embodying the computer program product of claim 16, wherein the program is further configured to use a pre-calculated correlation set of values between said discrepancy of values and a biodiesel percentage with respect to petrodiesel in order to determine a value of biodiesel blending.

20. The computer readable medium embodying the computer program product of claim 16, wherein the program is further configured to perform said first evaluation is performed by integrating an in-cylinder pressure trace provided by pressure-sensing glow plugs.
